(19) United States
(12) Patent Application Publication
(10) Pub. No.: US 2024/0151859 A1
(43) Pub. Date: May 9, 2024

(54) METHOD FOR ADAPTIVE LOCATION INFORMATION OBTAINMENT IN A WIRELESS NETWORK

(71) Applicant: Sony Group Corporation, Tokyo (JP)

(72) Inventors: Basuki PRIYANTO, Lund (SE); Rickard LJUNG, Helsingborg (SE); Torgny PALENIUS, Barsebäck (SE); Nafiseh Seyed MAZLOUM, Lund (SE); Johan HILL, Lund (SE); Anders BERGGREN, Lund (SE)

(21) Appl. No.: 18/279,561

(22) PCT Filed: Feb. 14, 2022
(86) PCT No.: PCT/EP2022/053465

§ 371 Date: Aug. 30, 2023

(30) Foreign Application Priority Data
Mar. 15, 2021 (SE) 2150294-3

(51) Int. Cl. G01S 19/48; G01S 5/00; G01S 5/02

(52) U.S. Cl. CPC G01S 19/48; G01S 5/0036; G01S 5/017; G01S 5/0236

(57) ABSTRACT

A method carried out in a user equipment, UE, (1) for generating location information to a location server (130) in a wireless network (100), the method comprising: receiving (404), from the location server, a location request message identifying a request for location information based on adaptive selection of a positioning method; receiving (404,408), from the wireless network, parameter information for the adaptive selection of the positioning method; obtaining (412) location information using the positioning method adaptively selected by the UE based on the parameter information; transmitting (414) the location information to the location server.

### TECHNICAL FIELD

This disclosure relates to the field of positioning, and specifically to generation of location information usable for determination of a location estimation of a wireless device attached to a wireless network. Specifically, the proposed solutions relate to obtaining location information in the wireless device using a positioning method which is adaptively selected under control of a location server in the wireless network.

### BACKGROUND

Location or positioning are terms frequently used in the field of wireless communication, for determining a location estimate of an actual position of a mobile device. The determined position or location may be related to a coordinate system, such as defined by e.g. geographical coordinates, or in relation to another position or object.

In 3GPP, (the 3^{rd} Generation Partnership Project) standards for New Radio (NR) and Long Term Evolution (LTE), the LTE Positioning Protocol (LPP) is used for handling positioning signaling between the mobile wireless communication device, herein referred to by the commonly used term user equipment (UE), and various servers in the network. Such servers may include e.g. Location Management Function (LMF), Evolved Serving Mobile Location Centre (E-SMLC) and SUPL (Secure User Plane Location) and Location Platform (SLP). Different positioning methods are used in 3GPP, Satellite-based with network assistance, Assisted-Global Navigation Satellite System (A-GNSS), time difference measurement methods such as Observed time difference of arrival (OTDOA), Uplink Time difference of arrival (UL-TDOA) and downlink time difference of arrival (DL-TDOA), Enhanced Cell-ID (ECID)/(NR-ECID), External Protocol Data Unit (EPDU), Sensors (Motion and Barometric), Terrestrial Beacon Systems (TBS), positioning systems in Local area networks such as wireless LAN (WLAN), Bluetooth, Round Trip Time methods (NR-Multi-RTT) and other angle of direction methods (NR-DL-AoD, NR-UL-AoA).

For UE-based or assisted positioning, a location server (LS) within the network can request location information from the UE over a positioning protocol, such as the LPP. The positioning protocol is specified in Technical Specification (TS) 37.355 with stage 2 specifications in TS 36.305 for LTE and TS 38.305 for NR. According to current specifications, the RequestLocationInformation message sent by the network to the UE contains the method(s) to be used. The location information given by the different technologies are independent and separately defined and each has its own accuracy performance given the circumstances. When responding to the Location Information request the location information is provided from the UE in the ProvideLocationInforrnation message, where the result from each requested method is reported.

The location information requested and reported in the Location Information can be either location estimates (UE-based) or location measurements (UE-assisted). A location estimate refers to an estimated location or position of the UE, whereas a location measurement refers to measurement data which can be used, in the LS, for determining an estimated location or position of the UE. In the protocol, each positioning method and whether it is UE based or UE assisted is requested independently from the server, and the server thus specifies which methods the UE shall use. Since the environment changes quite quickly for e.g. GNSS, due to shadowing of satellites, small movements of the UE may also change the accuracy of a location method. Therefore, improvements to the current specified signaling and procedures could be envisioned, to achieve better positioning performance for the intended use-case or services in such dynamic situations.

### SUMMARY

A need therefore exists for a method for controlling positioning to determine a location estimate of a UE connected to a wireless network. The proposed solution is defined by the terms of the independent claims.

According to a first aspect, the proposed solution inter alia relates to a method carried out in a user equipment, UE, for generating location information to a location server in a wireless network, the method comprising:
receiving, from the location server, a location request message identifying a request for location information based on adaptive selection of a positioning method;
receiving, from the wireless network, parameter information for the adaptive selection of the positioning method;
obtaining location information using the positioning method adaptively selected by the UE based on the parameter information;
transmitting the location information to the location server.

According to a second aspect, the proposed solution inter alia relates to a method carried out in a location server for obtaining location information for a UE connected through wireless network, the method comprising:
transmitting, to the UE, a location request message identifying a request for location information based on adaptive selection of a positioning method;
transmitting, to the UE, parameter information for the adaptive selection of the positioning method;
receiving location information obtained using the positioning method adaptively selected by the UE based on the parameter information.

By allowing adaptive selection of one or more of a plurality of positioning techniques, while maintaining control of the location obtainment in the LS by configuration of the parameter information, improved obtainment of location information is achieved, while minimizing signaling.

Various non-limiting examples falling within this general scope are laid out in the dependent claims and in the following description.

### BRIEF DESCRIPTION OF THE DRAWINGS

The proposed solutions will now be described in more detail with reference to the accompanying drawings, in which various examples of realizing the solutions are outlined.

FIG. 1 schematically illustrates a wireless network according to some examples, in which the proposed solutions may be set out.

FIG. 2 schematically illustrates a UE configured to operate in accordance with the examples laid out herein.

FIG. 3 schematically illustrates a location server configured to operate in accordance with the examples laid out herein.

FIG. 4 schematically illustrates a signaling diagram of various steps carried out in a method according to the proposed solution.

### DETAILED DESCRIPTION

In the following description, for purposes of explanation and not limitation, details are set forth herein related to various examples. However, it will be apparent to those skilled in the art that the present disclosure may be practiced in other examples that depart from these specific details. In some instances, detailed descriptions of well-known devices, circuits, and methods are omitted so as not to obscure the description of the present disclosure with unnecessary detail. The functions of the various elements including functional blocks, including but not limited to those labeled or described as “computer”, “processor” or “controller”, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented and are thus machine-implemented. In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) (ASIC), and (where appropriate) state machines capable of performing such functions. In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” shall also be construed to refer to other hardware capable of performing such functions and/or executing software, such as the example hardware recited above.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

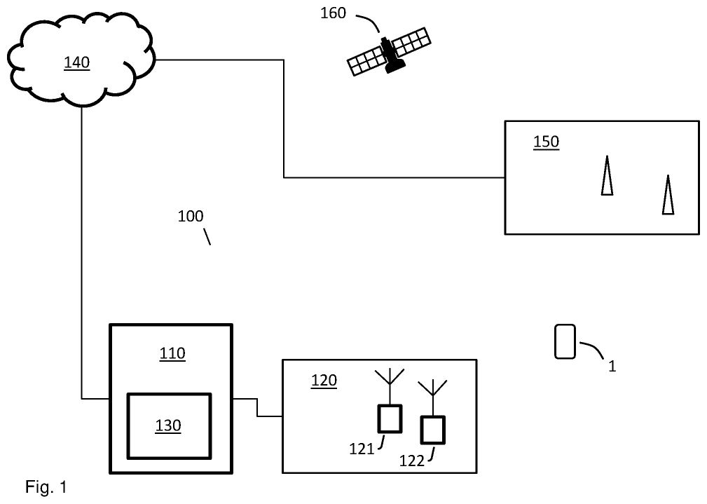

FIG. 1 schematically illustrates a wireless communication scenario, providing an example of a scene in which the solutions provided herein may be incorporated for providing a position estimation of a UE 1.

A wireless network 100 may comprise a core network 110 and one or more access networks 120. The wireless network may be configured according to at least some of the specifications as used by the 3GPP. The core network may e.g. be a 4G EPC or a 5G Core. The core network 110 may further be connected to other communication systems such as the Internet 140. A network node operating as a location server 130 may be connected in the core network 110. In an alternative example, the location server 130 does not form part of the core network 110 but is connected thereto. The access network 120 is connected to the core network 110 and is usable for communication with UEs, such as the illustrated UE 1. In another example, a location server 130 can be realized as part of Mobile Edge Computing (MEC) and it can be co-located in one of the access networks in order to reduce the latency. The access network 120 may comprise a plurality of access nodes or base stations 121, 122, configured to provide a wireless interface for, inter alia, the UE 1. In a 5G network an access node 121, 122 is typically referred to as a gNB, and this term will occasionally be referred to herein as well. The base stations 121, 122 may be stationary or mobile. The actual point of transmission and reception of each base station may be referred to as a Transmission and Reception Point (TRP), which may coincide with an antenna system of the respective base station.

The UE 1 may be any device operable to wirelessly communicate with the network 100 through the base stations 121, 122, such as a mobile telephone, computer, tablet, a machine to machine (M2M) device, an IoT (Internet of Things) device or other.

FIG. 1 further indicates other systems available to the UE 1 for generating location information usable for estimation of the position of the UE 1. In some examples, signals or information transmitted by other wireless transmitters 150 may be detectable in the UE 1, such as Wi-Fi transmitters or Bluetooth transmitters. Moreover, a plurality of satellite transmitters 160 may be provided for GNSS signal transmission.

Before discussing various process solutions for the proposed method, the UE 1 and the positioning server 130 will be functionally discussed on a general level.

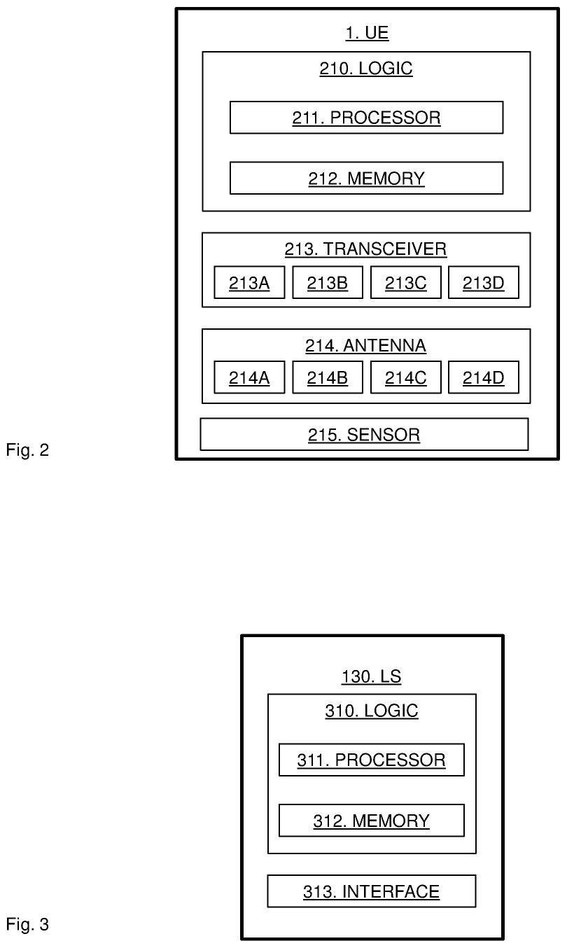

FIG. 2 schematically illustrates an example of the UE 1 for use in a wireless network 100 as presented herein, and for carrying out the method steps as outlined. The UE 1 may be a New Radio (NR) UE in which the UE is connected to a 5G NR cellular system 120.

The UE 1 comprises a radio transceiver 213 for communicating with other entities of the radio communication network 100, such as the base stations 121, 122 and other nodes 150, in various frequency bands. The transceiver 213 may thus include a radio receiver and transmitter for communicating through at least an air interface. As an example, the UE1 may comprise one or more of a transceiver 213A for communication with the access network 120, a transceiver 213B for Wi-Fi communication, a transceiver 213C for Bluetooth communication, and a receiver 213D for obtaining GNSS signals.

The UE 1 further comprises logic 210 configured to communicate data, via the radio transceiver, on a radio channel, to the wireless communication network 100 and possibly directly with another terminal by Device-to Device (D2D) communication.

The logic 210 may include a processing device 211, including one or multiple processors, microprocessors, data processors, co-processors, and/or some other type of component that interprets and/or executes instructions and/or data. The processing device 211 may be implemented as hardware (e.g., a microprocessor, etc.) or a combination of hardware and software (e.g., a system-on-chip (SoC), an application-specific integrated circuit (ASIC), etc.). The processing device 211 may be configured to perform one or multiple operations based on an operating system and/or various applications or programs.

The logic 210 may further include memory storage 212, which may include one or multiple memories and/or one or multiple other types of storage media. For example, the memory storage 212 may include a random access memory (RAM), a dynamic random access memory (DRAM), a cache, a read only memory (ROM), a programmable read only memory (PROM), flash memory, and/or some other type of memory. The memory storage 212 may include a hard disk (e.g., a magnetic disk, an optical disk, a magneto-optic disk, a solid state disk, etc.).

The memory storage 212 is configured for holding computer program code, which may be executed by the processing device 211, wherein the logic 210 is configured to control the UE 1 to carry out any of the method steps as provided herein. Software defined by said computer program code may include an application or a program that provides a function and/or a process. The software may include device firmware, an operating system (OS), or a variety of applications that may execute in the logic 210.

The UE 1 may further comprise an antenna system 214, which may include one or more antenna arrays. In various examples the antenna system 214 comprises different antenna elements configured to communicate with the wireless network 100, and optionally also antenna devices for communication with other nodes 150 and for reception of GNSS signals. As an example, the antenna system 214 may comprise one or more of an antenna 214A for communication with the access network 120, an antenna 214B for Wi-Fi communication, an antenna 214C for Bluetooth communication, and an antenna for receiving GNSS signals.

The UE1 may further comprise one or more sensors 215 usable for positioning of the UE1, such as a gyroscope, a barometer, an accelerometer etc.

Obviously, the UE 1 may include other features and elements than those shown in the drawing or described herein, such as a power supply, a casing, a user interface, further sensors, etc., but are left out for the sake of simplicity.

FIG. 3 schematically illustrates an example of the location server (LS) 130 for use in the wireless network 100 as presented herein, and for carrying out the method steps as outlined.

The LS 130 comprises a communication interface 313 for connection to the other nodes of the core network 110.

The LS 130 further comprises logic 310 configured to communicate measurement data and control signals with the access network 120 and with the UE 1, over one or more different interfaces 313. In various examples, communication with the access network 120 may be carried out using the NRPPa protocol, as outlined in TS 38.455, using an NG core network interface. Communication between the LS 130 and the UE 1 may be carried out using an LTE Positioning Protocol (LPP) as specified in 3GPP TS 37.355. The LS 130 further comprises logic 310 configured to communicate measurement data and control signals with the access network 120 and with the UE 1, over interface 313, e.g. by using an LTE Positioning Protocol (LPP) as specified in 3GPP TS 37.355 for the communication between LS and UE. The logic 310 may be partly or completely cloud-based or may be installed in a dedicated node device.

The logic 310 may include a processing device 311, including one or multiple processors, microprocessors, data processors, co-processors, and/or some other type of component that interprets and/or executes instructions and/or data. The processing device 311 may be implemented as hardware (e.g., a microprocessor, etc.) or a combination of hardware and software (e.g., a system-on-chip (SoC), an application-specific integrated circuit (ASIC), etc.). The processing device 311 may be configured to perform one or multiple operations based on an operating system and/or various applications or programs.

The logic 310 may further include memory storage 312, which may include one or multiple memories and/or one or multiple other types of storage mediums. For example, the memory storage 312 may include a random access memory (RAM), a dynamic random access memory (DRAM), a cache, a read only memory (ROM), a programmable read only memory (PROM), flash memory, and/or some other type of memory. The memory storage 312 may include a hard disk (e.g., a magnetic disk, an optical disk, a magneto-optic disk, a solid state disk, etc.).

The memory storage 312 is configured for holding computer program code, which may be executed by the processing device 311, wherein the logic 310 is configured to control the LS 130 to carry out any of the method steps as provided herein. Software defined by said computer program code may include an application or a program that provides a function and/or a process. The software may include device firmware, an operating system (OS), or a variety of applications that may execute in the logic 310.

Various techniques or methods for positioning of mobile devices are available, to obtain location information. One well-known technique involves multi-lateration (e.g. trilateration) and/or multi-angulation (e.g. triangulation) based on received signals, emitted or reflected from a known source. One example is satellite positioning, where positioning signals from satellite transmitters are measured. This may be referred to as Global Navigation Satellite System (GNSS), including a constellation of satellites providing signals from space that transmit positioning and timing data to GNSS receivers. A mobile device comprising a receiver for such signals may thus use this data to determine its position or location. The UE 1 may comprise receivers and logic for generation of location information according to several different techniques, including GNSS. One example is positioning in a cellular wireless network, e.g. operated as outlined in one or more of the technical specifications of 3GPP, (the 3^{rd} Generation Partnership Project). This may involve the UE receiving signals from a plurality of base stations of the wireless network, and measuring various characteristics of the received signals, such as one or more of signal strength, time of arrival (ToA), phase, etc.

In NR positioning, positioning techniques have been identified as dependent on, or independent of, Radio Access Technology (RAT). Examples of such positioning techniques may include the following RAT dependent positioning techniques, where UL denotes Uplink and DL denotes Downlink:
DL-TDOA
DL-AoD (Angle of Departure)
UL-AoA (Angle of Arrival)
UL-TDOA
Multi-RTT (Roundtrip time)
E-CID (Enhanced Cell Identification)

Examples of RAT independent positioning techniques may include:
GNSS
Wi-Fi
Bluetooth
Barometer sensor
Motion sensor
Terrestrial Beacon System (TBS)

An estimate of the position or location of the UE 1 can be calculated based on the location measurement obtained by the UE 1. In some examples a location estimate is determined by the UE 1, based the location measurement. In some examples, the location server 130 controls the signaling and positioning process, and may perform the calculations for determination of the location estimation, based on location measurement obtained from the UE 1. One example of such a technique is UE-assisted OTDOA. The UE performs measurement, such as Reference Signal Time Difference (RSTD) measurement and then reports the results to the Location Server to be used for positioning estimation.

Different types of positioning techniques provide location information with different characteristics, such as accuracy, latency, availability etc. GNSS positioning may for instance provide a location estimation accuracy which may be within 10m, whereas network-based techniques in 4G systems typically provided a lower positioning accuracy of e.g. 50 m or worse. On the other hand, the availability of GNSS signals is normally not particularly good in indoor environments and in urban scenarios. Other techniques, such as utilizing Bluetooth signals, Wi-Fi signals, inertial measurement sensors, can be used to complement positioning estimation technique in indoor environments.

As noted, a location, such as geo-location coordinates, of the UE 1 can be estimated in the location server 130 or in the UE 1. If needed, the determined location estimation of the UE can then be communicated back to the UE 1, e.g. when the UE is in RRC (Radio Resource Control) connected mode. However, in 3GPP release 16 “UE based positioning” was introduced, where the UE 1 itself can estimate its position by utilizing the received positioning reference signal from TRP(s) and TRP(s) geo-location information, i.e. a location estimate, such as geo-location coordinates. Moreover, further studies have recently been initiated with the objective to address higher accuracy location requirements resulting from new applications and so-called industry verticals.

In the legacy UE positioning, the UE is requested to provide location measurement/estimation using a network-selected positioning technique, each time the LS has a need for the UE location. The selected positioning technique may not always be the best positioning technique that can provide the intended positioning accuracy/latency. Herein, a method is proposed for the LS 130 to be able to order the UE 1 to obtain location information using adaptive positioning techniques to allow better positioning techniques for intended use-cases or services. This can be facilitated, for example, by deploying Artificial Intelligence/Machine Learning (AI/ML) at the LS 130 side.

In various examples, the LS 130 is thus configured to determine parameter information for use in the UE 1, so as to configure the UE 1 to select the appropriate positioning technique, or method, given current context or circumstances of the UE at the time of obtaining location information.

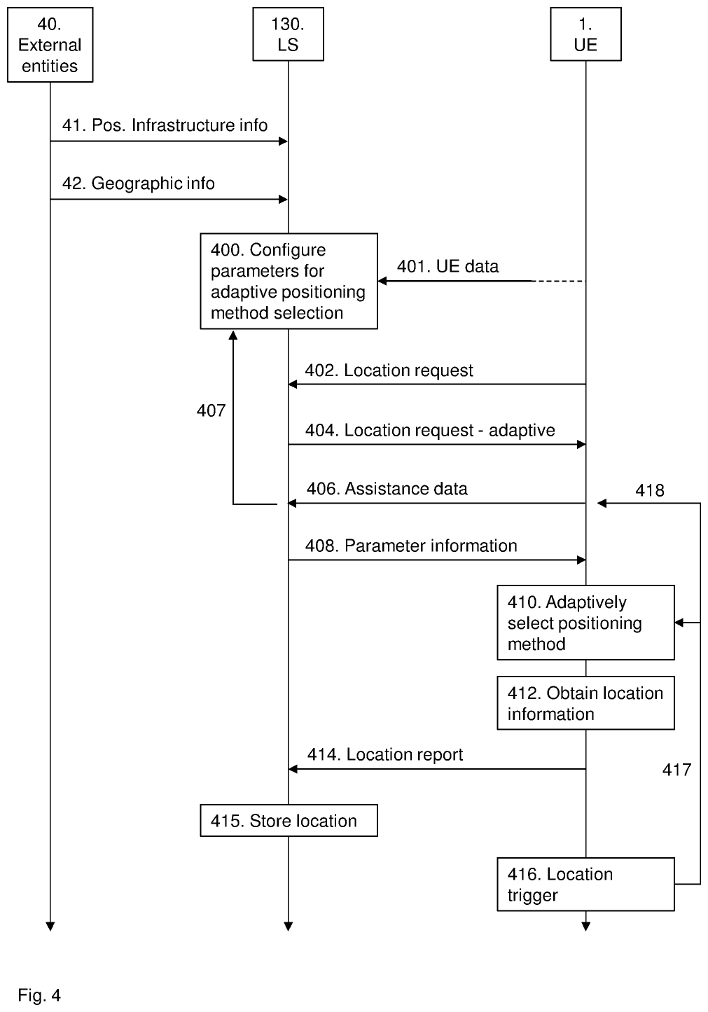

Certain examples of the proposed solution will now be described with reference to FIG. 4, which provides a signaling diagram showing different features and aspects according to various examples of the proposed solution. Therein, various steps are carried out by the LS 130 and the UE 1, respectively, including communication of signals and data therebetween. It may be noted that the solution provided herein, and as exemplified with reference to FIG. 4, may on the one hand be carried out in the UE 1 under control of the logic 210, wherein the processor 211 may be configured to execute computer program code stored in the memory storage 212 to control the UE 1. Similarly, the solution provided herein, and as exemplified with reference to FIG. 4, may on the other hand be carried out in the LS 130 under control of the logic 310, wherein the processor 311 may be configured to execute computer program code stored in the memory storage 312 to control the LS 130.

In general terms, and from the viewpoint of the UE 1, a method is provided for generating location information to the LS 130, to which the UE 1 is connected through a wireless network 100. The method comprises:
receiving, from the location server, a location request message identifying a request for location information based on adaptive selection of a positioning method;
receiving, from the wireless network, parameter information for the adaptive selection of the positioning method;
obtaining location information using the positioning method adaptively selected by the UE based on the parameter information;
transmitting the location information to the location server.

In step 400, the LS 130 may determine and configure the parameter information, which controls how the UE is configured to select positioning technique.

The parameter information may comprise a plurality of positioning techniques between which the UE 1 will be configured to adaptively select one or more positioning techniques. The plurality of positioning techniques may comprise one or more RAT dependent techniques and/or one or more RAT independent techniques. The plurality of positioning techniques may be dependent on UE capability information, associated with the UE 1, e.g. only comprising positioning techniques which the UE 1 is capable of performing. The UE capability information may be provided by the UE 1 upon registering to the wireless network 100, or later.

The parameter information may be associated with a specific location request message, transmitted 404 from the LS 130 to the UE 1. The parameter information may be updated in the LS 130, based on e.g. time or context of the UE 1.

The parameter information may further identify, or comprise, triggering criteria which controls the selection carried out in the UE 1 of positioning technique(s) to use for obtaining location information. The triggering criteria to perform adaptive positioning may be statically defined, e.g. defined in or by technical specifications or provided as system information from the network 100. Alternatively, in order to provide more flexibility, the LS 130 may provide more specific triggering criteria, which may be e.g. specific to the UE 1, a group or type of UEs, valid for a certain period of time, valid for a certain region or area such as for a given cell, valid for use in a certain network type, associated with a particular location request.

The triggering criteria may comprise one or more of a time-based criterion and a threshold criterion of signal measurements obtained in the UE 1.

A time-based criterion may, by way of example, provide that the UE 1 is configured to use a first positioning technique in association with a first time parameter T1, and further to use a second positioning technique in association with a second time parameter T2. The time parameters T1, T2 may e.g. be defined as starting time points or time periods.

A threshold criterion may, by way of example, provide that the UE 1 is configured to use a certain positioning technique if a signal strength, measured in the UE 1, is below a certain threshold level, and another positioning technique if the measured signal strength exceeds the threshold level. The signal strength may e.g. be related to received GNSS signals, received signals from base stations 121, 122 of the wireless network 100, or from other signal sources 150.

Yet another criterion may be dependent on a location area of the UE, such as a cell served by a base station 121, a larger area within which the UE 1 is present such as a paging area, or a type of area such as rural, urban etc.

The triggering criteria may comprise a combination of different types of criteria, such as any combination of the above examples.

In some examples, the parameter information identifies a priority of at least one positioning technique. The identified priority may comprise a priority order of the plurality of positioning techniques, thereby configuring the UE 1 to select the positioning technique with highest priority which also satisfies the triggering criteria. In one example, the identified priority may provide one or more identified positioning techniques the UE 1 is configured to always use, even if another positioning technique is additionally adaptively selected based on the triggering criteria.

The parameter information may be configured by the LS 130 based on assistance data 406 from the UE 1. The assistance data 406 may be provided on request, such as based on a location request from the LS 130, or periodically, or responsive to the UE 1 determining that a certain UE parameter changes more than a level of significance to trigger the UE 1 to transmit the assistance data 406. The assistance data 406 may identify or be based on a current context of the UE 1, e.g. a mobility of the UE 1 and/or an area or environment of the present location of the UE 1. Some examples include the UE 1 detecting bad radio conditions, a sudden change of radio condition, or a change of spatial context such as the UE 1 entering in-doors and losing GNSS connection, or the UE 1 moving at a speed exceeding a certain threshold.

The parameter information may further be configured by the LS 130 based on information obtained from other sources. For example, UE data, such as signal strength measurements associated with different types of sources used in different positioning techniques, or obtained location information, may be received 401 from a plurality of UEs connected to the wireless network 100, including the UE 1. Specifically, location information obtained from other UEs in a common context as the UE 1 may be used in the LS 130 to adapt and improve the configuration 400 of the parameter information.

The parameter information may further be configured by the LS 130 based on positioning system information reception at the LS 130 related to external systems 40. This may include the LS 130 receiving information related to positioning infrastructure information 41 from sources 150 associated with RAT independent positioning methods. This may include e.g. Wi-Fi infrastructure, Bluetooth beacon transmitter, and Terrestrial Beacon system (TBS). Here, an interface at the LS 130 is defined, depending on if the positioning system 150 is outside the operator controlled domain, or whether the system 150 is within the operator domain, and hence may have a defined interface, like Wi-Fi interworking function.

The parameter information may further be configured by the LS 130 based on geographical map information 42, e.g. including building information, and expected traffic conditions.

Configuration of the parameter information based on the obtained information and data may include setting or changing triggering criteria, and/or adding or deleting positioning methods to the plurality of positioning methods, and/or changing priority settings. Updated parameter information may be transmitted 408 to the UE 1 based on, or included in, a location request message 404, or by periodic update, or responsive to the parameter information being update.

Configuration of the parameter information may be carried out by computation in the LS 130 based on multiple input, including obtained UE data 401 received from other UEs in the network 100, and assistance data specifically received from the UE 1. The computation of the parameter information may further be based on information from external entities.

In some examples, configuration of the parameter information in the LS 130 is based on Artificial Intelligence (AI)/Machine Learning (ML) operation. UE data 401 from UEs in the network 100, specific assistance data 406 obtained from the UE 1, as indicated by 407, and/or information 41/42 obtained from external entities, may be used to set or change weighting parameters for ML computation. Use and deployment of the ML method may be implementation specific, and the specific implementation of such an ML method is as such not essential. A few aspects of ML are nevertheless described herein, to give a background and rationale to some example implementations. The ML method may be applied to improve the configuration of the parameter information, such that a positioning technique which is suitable in current circumstances of the UE 1 are in fact selected, based on the parameter information. The configuration of the parameter information, such as the triggering criteria, may be performed by use of an ML method, which may comprise a machine learning-based model, or ML model for short. An ML model, also known as a machine learning algorithm, is a mathematical algorithm which, when implemented on a computer resource, has the ability to automatically learn and improve from experience without being explicitly programmed. In some examples, the ML model is based on so-called supervised or semi-supervised learning algorithms, which are configured to build a mathematical model on training data. The resulting mathematical model is thus “trained” and is denoted trained ML model. The training data comprises a set of training examples. Each training example has one or more inputs and the desired output. The outputs may be represented by an array or vector, sometimes called a feature vector, and the inputs may be represented by one or more matrices. Through iterative optimization, learning algorithms learn a function that can be used to predict the output associated with new inputs. The ML model may be based on any suitable architecture, including but not limited to convolution neural networks (CNNs).

In the context of the proposed solution, training data may be provided by means of information or data collected or determined by the UE 1, such as timing measurement, measured signal strength, measurement quality, phase, polarization, or other signal characteristics of signals received from different transmitters, e.g. GNSS satellites, base stations of the wireless network 100, and other transmitters 150. Moreover, training data may be obtained by UE data 401 from other UEs in the network 100, and potentially from data obtained from external entities 40. Training data may also be the resulting positioning accuracy, provided by a selected positioning method, based on in-data, such as e.g. present context of the UE. Based on a finalized configuration of parameter information, the ML model may be trained to update the configuration parameters given a certain context of the UE 1. The context may be a certain physical area, such as a cell, an area type, such as rural, urban, indoor. The context may be a certain radio environment, identified by a certain type, character, quality, strength, or other parameter, of radio signal(s) detected in the UE 1. Specifically, the ML model may be trained by a multitude of UEs attempting to obtain location information within a general area, such as within a cell served by a base station 121, and thereby collecting data for use as training data. By means of the ML model, an improved configuration of parameter information may be obtained, wherein the UE 1 may be configured to select a positioning method based on the parameter information, which is suitable in the given context.

Returning to FIG. 4, the LS 130 transmits 404 a location request message. In some examples, an indication in the message may identify the request as “Location request—adaptive”, which provides that the UE shall select positioning technique based on parameter information. The location request message 404 may be triggered by the UE 1 being internally triggered to seek location information, and thereby transmitting 402 a request to the wireless network 100 to that effect. If the LS 130 agrees, the LS 130 responds to the UE 1 by transmitting 404 “Location request—adaptive”.

The UE 1 further receives 408 parameter information from the wireless network 100, for the adaptive selection of a positioning method. In the drawing, the parameter information is received from the LS 130, but it may alternatively originate from another node in the network, though being configured in the location server 130.

The parameter information may be received in one or more separate messages 408, as illustrated, or in the location request message 404 indicating adaptive selection of positioning technique.

In response to the location request, the UE 1 is configured to obtain 412 location information using the positioning method adaptively selected by the UE based on the parameter information. This obtainment inherently comprises an adaptive selection 410 of the positioning method, based on the parameter information.

In step 414, a location report is transmitted to the LS 130. As noted, the location information may comprise a location measurement and/or a location estimate. Moreover, the location report may comprise location information obtained with more than one positioning method, as configured by the parameter information, transmitted in one or more separate messages 414.

The UE 1 may be configured to transmit an indication, to the LS 130, of the positioning method that was used for obtaining the reported 414 location information. This indication may be conveyed in the location report message 414 or separately.

As the LS 130 receives the location report from the UE 1 with time stamp (legacy), a location estimate may be stored 415, and possibly be determined based on the received location information. In order to facilitate ML operation, the LS may cluster/group the positioning data information based on the positioning techniques, group the results based on the estimated position at a given time. Here, basically the LS provides labelling to the positioning report from the UE 1 or multiple UEs, for use in operation of the ML model.

In some examples, the UE 1 is triggered to transmit assistance data 406, as discussed, responsive to the location request message 404. Optionally, parameter information is updated, or re-configured, in the LS 130 based on the assistance data 406, i.e. the configuration step 400 carried out, or repeated, after the assistance data 406 is received in the LS 130, and before the parameter information 408 is transmitted.

At various instances, the UE 1 may experience a change of context, as noted. This may trigger 416 the UE 1 to make a new selection 410 of positioning technique based on the parameter information, as indicated by arrow 417 leading to box 410. Additionally, or alternatively, the UE 1 may be triggered 416 to transmit new assistance data 406 to the LS 130, as indicated by arrow 418, for subsequent re-configuration 407, 400 of the parameter information, and receipt 408 of the re-configured parameter information.

The solution as proposed and described herein provides an improved method, and device configuration of the UE 1 and the LS 130, for obtainment of location information. By allowing adaptive selection of one or more of a plurality of positioning techniques, while maintaining control of the location obtainment in the LS 130 by configuration of the parameter information, improved obtainment of location information is achieved. For example, the method may provide location information which has higher quality than a simple ordered default positioning method, e.g. in terms of lower latency and/or higher accuracy. At the same time, the adaptive selection minimizes excessive signaling, as would be the case when separately requesting location information using different positioning methods. Moreover, the improved location information obtainment process is obtained without sacrificing processing and energy consumption in the UE 1, since the UE 1 is not required to successively attempt several positioning methods.

1. A method carried out in a user equipment (UE) for generating location information to a location server in a wireless network, the method comprising:
receiving, from the location server, a location request message identifying a request for location information based on adaptive selection of a positioning method;
receiving, from the wireless network, parameter information for the adaptive selection of the positioning method;
obtaining location information using the positioning method adaptively selected by the UE based on the parameter information;
transmitting the location information to the location server.

2. The method of claim 1, comprising:
transmitting assistance information, associated with a present context of the UE, to the location server in response to the location request message, for use in the location server to configure said parameter information.

3. The method of claim 2, wherein said context identifies at least one of a mobility of the UE, and an area or environment of the present location of the UE.

4. The method of claim 1, comprising:
adaptively selecting the positioning method from a plurality of positioning methods.

5. The method of claim 4, wherein said plurality of positioning methods are identified by the parameter information.

6. The method of claim 4, wherein said plurality of positioning methods are identified in the location request message.

7. The method of claim 1, wherein the location information is obtained using a positioning method which is adaptively selected based on triggering criteria, identified by the parameter information.

8. The method of claim 7, wherein said triggering criteria comprise one or more of a time-based criterion and a threshold criterion of signal measurements obtained in the UE.

9. The method of claim 1 wherein the parameter information identifies a priority of at least one positioning method.

10. The method of claim 1 comprising:
transmitting an indication of the used positioning method to the location server.

11. A method carried out in a location server for obtaining location information for a user equipment (UE) connected through wireless network, the method comprising:
transmitting, to the UE, a location request message identifying a request for location information based on adaptive selection of a positioning method;
transmitting, to the UE, parameter information for the adaptive selection of the positioning method;
receiving location information obtained using the positioning method adaptively selected by the UE based on the parameter information.

12. The method of claim 11, comprising:
receiving assistance information from the UE, associated with a present context of the UE;
configuring said parameter information based on the assistance information.

13. The method of claim 11, comprising:
obtaining positioning environment information, comprising at least one of positioning infrastructure of one or more positioning methods, and map information.

14. The method of claim 13, comprising:
receiving assistance information from the UE, associated with a present context of the UE; configuring said parameter information based on the assistance information; and
configuring said parameter information based on the obtained positioning environment information associated with an area of the location of the UE, identified by said context.

15. The method of claim 12, wherein said context identifies at least one of a mobility of the UE, and an area or environment of the present location of the UE.

16. The method of claim 11, comprising:
identifying, to the UE, a plurality of positioning methods from which adaptive selection is to be made.

17. The method of claim 16, wherein said plurality of positioning methods are identified by the parameter information.

18. The method of claim 16, wherein said plurality of positioning methods are identified in the location request message.

19. The method of claim 11, comprising:
providing, to the UE, triggering criteria for adaptively selecting positioning method in the UE.

20. The method of claim 19, wherein said triggering criteria comprise one or more of a time-based criterion and a threshold criterion of signal measurements obtained in the UE.

21-22. (canceled)
